(19) United States
(12) Patent Application Publication
(10) Pub. No.: US 2026/0217504 A1
(43) Pub. Date: Jul. 30, 2026

(54) VEHICLE LIFTING DEVICE

(71) Applicants: Christopher Jan Jarek Hobbs, Calgary (CA); Barry Saik, Calgary (CA); Jerrod Oostenbrink, Zeballos (CA)

(72) Inventors: Christopher Jan Jarek Hobbs, Calgary (CA); Barry Saik, Calgary (CA); Jerrod Oostenbrink, Zeballos (CA)

(21) Appl. No.: 19/574,533

(22) Filed: Mar. 23, 2026

Related U.S. Application Data
(63) Continuation-in-part of application No. 18/905,223, filed on Oct. 3, 2024, now Pat. No. 12,643,777.

(51) Int. Cl. B66F 3/24

(52) U.S. Cl. CPC B66F 3/24

(57) ABSTRACT

A vehicle lifting device configured to lift a portion of a vehicle or other object wherein the device employs compressed air to raise and lower the vehicle lifting device. The device includes a base plate member wherein the base plate member includes a center portion and support arms radially extending outward therefrom being coplanar therewith. Three articulating arm members are operably coupled to the base plate member. The articulating arm members include a lower portion and an upper portion that are pivotally secured. The upper portion of the articulating arm members are operably coupled with a top support plate member. An air bladder member is intermediate the base plate member and top support plate member and is movable in an upwards-downward motion employing compressed air. An extension member is releasably secured to the upper surface of the top support plate member.

### CROSS-REFERENCE TO RELATED APPLICATIONS

This application is a continuation-in-part of U.S. application Serial. No. 18/905,223, filed October 3, 2024, which is currently pending. The entire disclosure of the prior application is hereby incorporated by reference

### FIELD OF THE INVENTION

The present invention relates generally to vehicle lifting systems, more particularly to automobile jacks used to raise a portion of a vehicle for service activities such as tire changes, brake work, and roadside repairs. The present invention is a portable air driven lifting device for a vehicle that includes an air bladder member having three articulating arm members surroundably present thereto wherein the lifting device is operable to move in an upwards-downwards motion.

### BACKGROUND

Automobile jacks are commonly provided with vehicles or carried by users to permit lifting of a vehicle in a roadside environment. Conventional jacks include mechanical jacks such as scissor jacks, screw jacks, ratcheting jacks, and lever-operated mechanisms, as well as hydraulic floor jacks and bottle jacks. Mechanical jacks, particularly the OEM-supplied scissor jack, remain widespread due to low cost, compact form factor, and minimal maintenance requirements. Despite their prevalence, mechanical jacks present persistent challenges in operation, ease of use, and lifting speed. For example, scissor and screw-based jacks typically require repeated manual rotation of a crank or handle to generate lift. This manual input is often slow and fatiguing, especially when the user is kneeling or working at an awkward angle beside a vehicle. The required number of turns can be substantial even for modest lift heights, resulting in extended setup and lifting times during roadside events where speed and safety are important.

Ease of use is further impacted by the torque and force required to initiate lifting, which can increase substantially depending on vehicle weight distribution, uneven ground, corrosion or contamination of threads, and misalignment between the jack saddle and the vehicle’s jack point. Users with limited strength, reduced mobility, injuries, or time constraints may struggle to raise a vehicle with a purely mechanical jack. Additionally, the operating handle or crank can slip, bind, or require repositioning due to limited clearance, causing intermittent progress and increasing user frustration. Mechanical jacks can also be sensitive to placement and stability. The small footprint typical of compact mechanical jacks may be more prone to shifting on soft ground, gravel, or inclined surfaces. If the jack is not positioned correctly under the designated lift point, or if the user inadvertently applies lateral forces while cranking, the jack may tilt, walk, or lose stable engagement. These issues can be exacerbated in adverse weather, low-light conditions, and confined roadside environments. Speed limitations are another drawback. Mechanical advantage mechanisms rely on incremental manual inputs, and practical lifting speed is constrained by human endurance and ergonomics. During roadside tire changes, delays in lifting can increase exposure to traffic hazards. Conversely, users may attempt to accelerate operation through improvised power tools or excessive force, which can damage the jack mechanism, strip threads, or create unsafe dynamic loading.

Accordingly, there is an ongoing need in the art for improved lifting solutions that address the operational burdens and slow lift rates of conventional mechanical jacks while preserving portability. In particular, the field of invention could benefit from compact air-driven lifting jacks capable of rapidly raising a vehicle with reduced manual effort, improved user ergonomics, and quicker lift initiation, while still being suitable for storage and deployment in typical automotive settings.

### SUMMARY OF THE INVENTION

It is the object of the present invention to provide an air driven lifting device to be utilized on vehicles and other objects wherein the present invention includes a base plate having a center portion and integrally formed radially dispersed support arm members extending outward therefrom.

Another object of the present invention is to provide a vehicle lifting device wherein the center portion of the base plate has an air bladder member superposed thereto.

A further object of the present invention is to provide an air driven lifting device to be utilized on vehicles and other objects wherein the present invention includes three articulating arm members operably coupled to the base plate surroundably present to the air bladder member.

Yet a further object of the present invention is to provide a vehicle lifting device wherein the three articulating arm members are identically constructed and include a lower portion and an upper portion.

Still another object of the present invention is to provide an air driven lifting device to be utilized on vehicles and other objects wherein the lower portion of the three articulating arm members are pivotally coupled to the base plate.

An additional object of the present invention is to provide a vehicle lifting device wherein the present invention further includes a top support plate member that is superposed the upper end of the air bladder member.

Yet a further object of the present invention is to provide an air driven lifting device to be utilized on vehicles and other objects wherein the upper portion of the three articulating arm members are pivotally coupled to the top support plate member.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a detailed view of an articulating arm member in a fully extended position; and

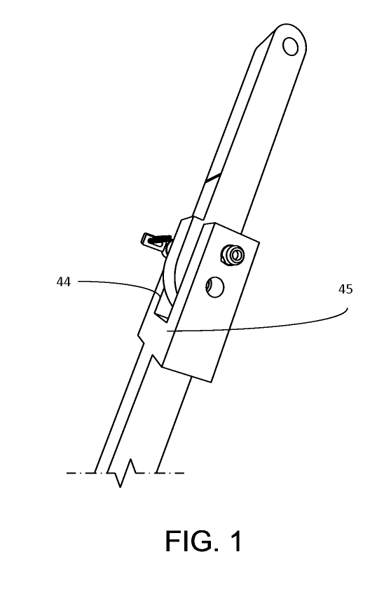

FIG. 2 is a detailed view of an articulating arm member in a partially retracted position; and

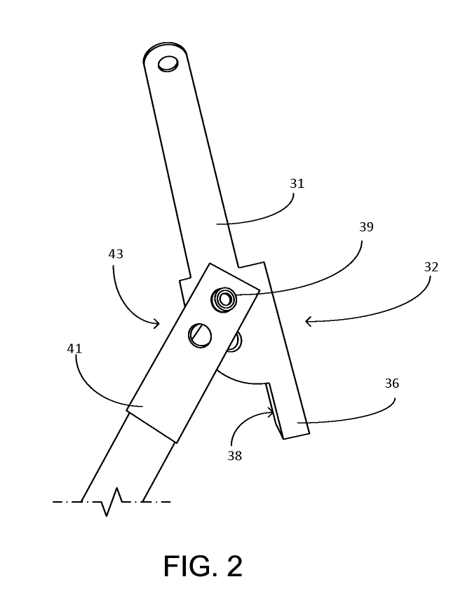

FIG. 3 is a top perspective view of the present invention; and

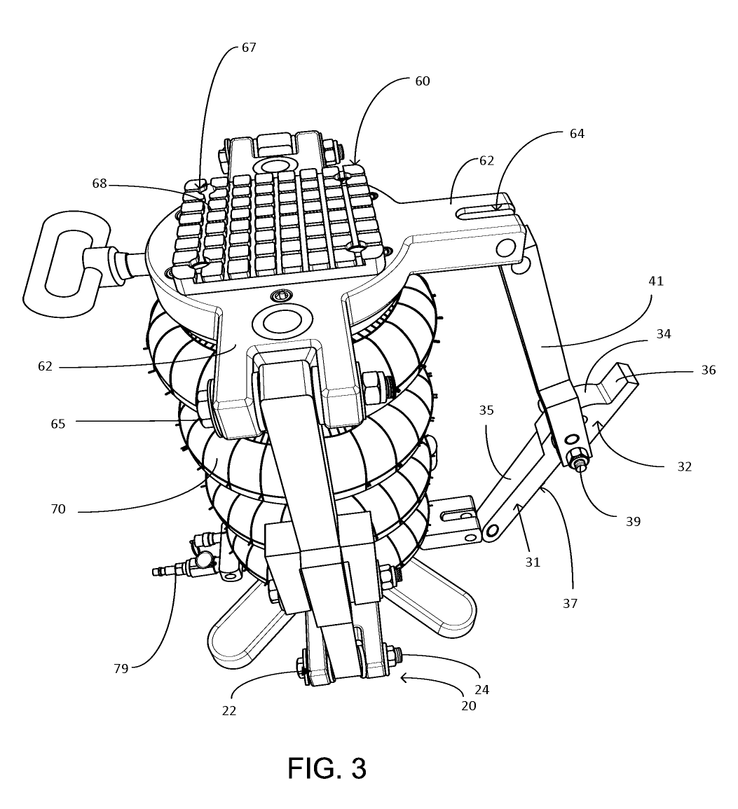

FIG. 4 is a side view of the present invention in an upwardly extended position; and

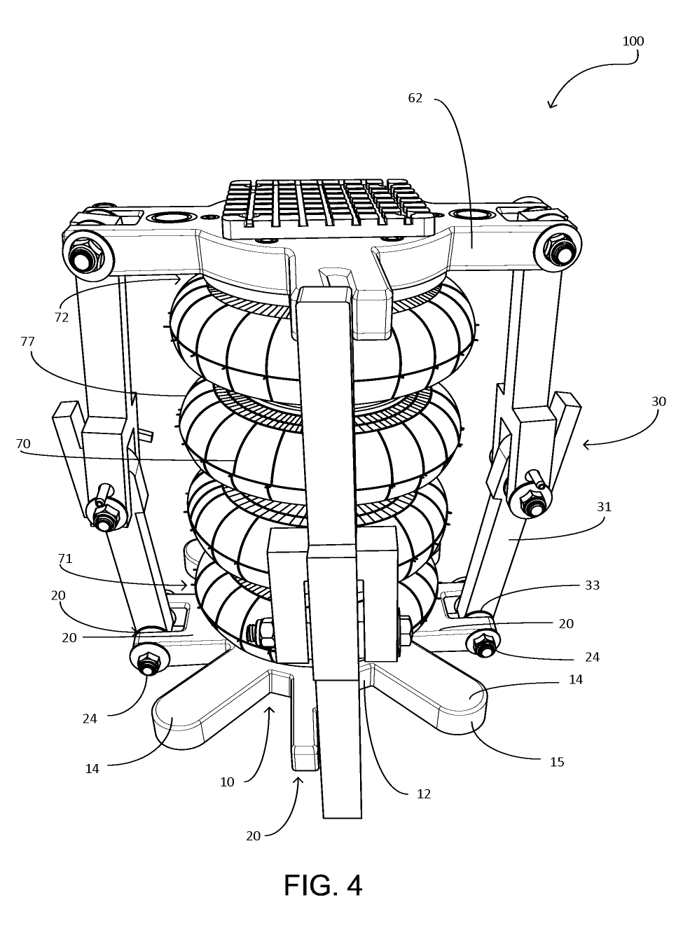

FIG. 5 is a top view of the present invention showing the extension member; and

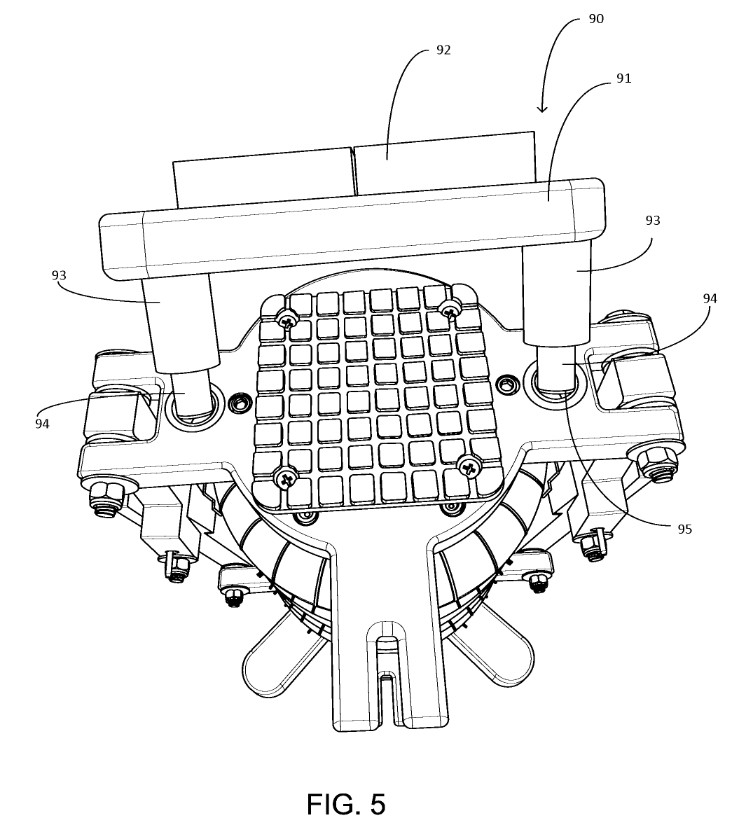

FIG. 6 is a detailed view of an end of the extension member.

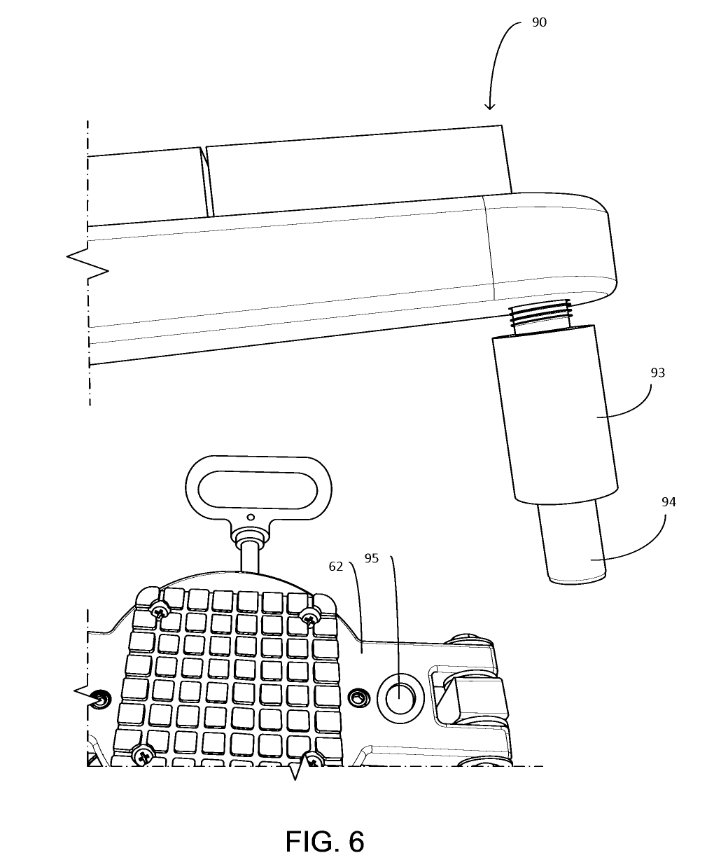

### DETAILED DESCRIPTION

Referring now to the drawings submitted herewith, wherein various elements depicted therein are not necessarily drawn to scale and wherein through the views and figures like elements are referenced with identical reference numerals, there is illustrated a vehicle lifting device 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted herewith, the vehicle lifting device 100 is operable to be placed under a suitable location of a vehicle to provide lifting thereof. It should be understood within the scope of the present invention that the vehicle lifting device 100 could be utilized solely or in groups thereof to provide lifting of a portion or all of a vehicle. It should further be understood within the scope of the present invention that the vehicle lifting device 100 could be manufactured in alternate sizes in order to provide lifting heights of varying ranges.

The vehicle lifting device 100 includes a base plate member 10 wherein the base plate member 10 is planar in manner being manufactured from a suitable rigid material such as but not limited to metal. The base plate member 10 includes center portion 12 wherein the center portion 12 is annular in shape. Formed along the circumferential edge of the center portion 12 are a plurality of support arm members 14. The support arm members 14 are integrally formed with the center portion 12 and radially disposed completely thereabout. The support arm members 14 are coplanar with the center portion 12 being axially aligned therewith. The support arm members 14 have a rounded end 15 and are configured to ensure balance of the vehicle lifting device 100 during utilization thereof. Interspersed between the support arm members 14 are three mounting arm members 20. The three mounting arm members 20 are coplanar with the center portion 12 and identically constructed. The three mounting arm members 20 have approximately ninety degrees of separation therebetween along the circumference of the center portion 12. The three mounting arm members 20 are configured to operably coupled to the lower portion 31 of the articulating arm members 30. Each mounting arm member 20 is identically constructed having coupling end portion 22 formed as a generally square U-shaped receiver. A hole is formed in the coupling end portion 22 wherein the hole is configured to have pin member 24 journaled therethrough. Pin member 24 functions to pivotally couple the lower end 33 of the lower portion 31 of the articulating arm member 30. It should be understood within the scope of the present invention that the pin member 24 could be a metal pin, bolt or other type of suitable fastener.

The three articulating arm members 30 are identically constructed and as such the ensuing discussion should be understood to apply to all three articulating arm members 30. The articulating arm member 30 includes a lower portion 31 and an upper portion 41 that are pivotally coupled utilizing fastener 39. Lower end 33 is operably coupled to coupling end portion 22 as previously discussed herein. The lower portion 31 includes upper end 32 having an integral formation that provides automated lockout once the air bladder member 70 has been fully inflated. The upper end 32 includes arcuate shaped portion 34 that is contiguously formed with the upper surface 35 of the lower portion 31. Arcuate shaped portion 34 terminates into extension segment 36 wherein extension segment 36 is coplanar with lower surface 37 of the lower portion 31. The extension segment 36 includes flat surface 38 wherein the flat surface 38 will be adjacent the lower end 43 during full extension of the articulating arm member 30. The combination of the extension segment 36 and arcuate shaped portion 34 provide a technique to provide a mechanical lockout at full extension of the articulating arm members 30.

The lower end 43 of the upper portion 41 is surroundably mounted to the upper end 32 having opposing leg members 44,45 located on opposite sides of the upper end 32. Pivotal coupling of the lower end 43 and upper end 32 is provided by fastener 39. The aforementioned description of the articulating arm member 30 is a preferred embodiment of the present invention. However, it is contemplated within the scope of the present invention that the articulating arm members 30 could be constructed in alternate manners in order to achieve the desired objective discussed herein. Additionally, while three articulating arm members 30 are illustrated herein, it is contemplated within the scope of the present invention that the vehicle lifting device 100 could have as few as two or more than three articulating arm members 30. As illustrated herein the mounting arm members 20 have ninety degrees of separation therebetween. For an embodiment having two articulating arm members 30, a separation of approximately one hundred and eighty degrees would exist. The upper portion 41 is pivotally coupled to leg member 62 of the top support plate 60. Leg member 62 is integrally formed with the top support plate 60 extending outward therefrom. The leg member 62 includes notch 64 formed therein that facilitates surroundable mounting of the upper portion 41. Fastener 65 is configured to pivotally couple the upper end of the upper portion 41 into the notch 64. The top support plate 60 includes upper surface 67 having a multitude of formations 68 thereon that are configured to provide secure engagement with an underside of a vehicle or portion of an object being lifted by the vehicle lifting device 100. It is contemplated within the scope of the present invention that the upper surface 67 could be configured in various alternate manners in order to ensure desired engagement with a surface of an object being lifted.

The vehicle lifting device 100 includes an air bladder member 70. The air bladder member 70 includes a lower end 71 superposed the base plate member 10 with the upper end 72 being adjacent the top support plate 60. The air bladder member 70 is manufactured from a durable expandable material such as but not limited to rubber and includes outer wall 77 that is accordion-style in order to facilitate the inflation and deflation thereof. As the air bladder member 70 is inflated the vehicle lifting device 100 is moved upwards in a vertical direction and opposedly when the air bladder member 70 is deflated the vehicle lifting device 100 moves in a downward direction. The air bladder member 70 is operated utilizing conventional compressed air and is operably coupled to a compressed air source utilizing coupler 79. It is further contemplated within the scope of the present invention that the vehicle lifting device 100 could be equipped with an onboard compressor and power supply in order to provide compressed air to operate the air bladder member 70.

Operably coupled to the top support plate member 60 is the extension member 90. The extension member 90 is utilized for vehicle or other objects that are out of the lifting range for the vehicle lifting device 100. The extension member 90 includes base member 91 manufactured from a durable rigid material such as but not limited to metal. The base member 91 has a length that is sufficient to extend across the width of the top support plate 60. The base member 91 has operably coupled to the upper surface thereof block member 92. Block member 92 is manufactured from a durable rigid material that is configured to provide improved engagement with a surface of a vehicle. Furthermore, the block member 92 provides additional height to the extension member 90 so as to improve the lifting range of the vehicle lifting device 100. Rotatably coupled to the base member 91 extending downward from the lower surface of the base member 91 are mounting posts 93. Mounting posts 93 are operably coupled to the base member 91 utilizing threads which further provides variability in the height adjustment of the extension member 90. Mounting posts 93 include lower end 94 wherein lower end 94 has a smaller diameter and is configured to be journaled into hole 95 formed in the top support plate 60. It is contemplated within the scope of the present invention that the extension member 90 could be releasably secured to the top support plate member 91 utilizing alternate elements and/or techniques.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A vehicle lifting device operable to utilize compressed air for operation thereof wherein the vehicle lifting device comprises:
a base plate member, said base plate member being planar in manner having a center portion, said center portion having a plurality of support arms extending outward therefrom being coplanar therewith, said base plate member further having at least two mounting arm members, said at least two mounting arm members extending outward from said center portion being coplanar therewith, said at least two mounting arm members being interspersed said plurality of support arms;
an air bladder member, said air bladder member being superposed said base plate member, said air bladder member having a lower end and an upper end, said air bladder member configured to be inflated and deflated expanding and contracting along a vertical axis;
a top support plate, said top support plate being superposed said upper end of said air bladder member being operably coupled thereto, said top support plate being planar, said top support plate having at least two leg members integrally formed therewith extending outward therefrom; and
at least two articulating arm members, said at least two articulating arm members being operably coupled to said at least two mounting arm members and said at least two leg members, said at least two articulating arm members being exteriorly adjacent said air bladder member, said at least two articulating arm members having a lower portion and an upper portion, said lower portion and said upper portion being pivotally coupled, said lower portion of said at least two articulating arm members having a lower end and an upper end, said upper portion of said at least two articulating arm members having a lower end and an upper end, said lower end of said lower portion being pivotally coupled to said at least two mounting arm members, said upper end of said upper portion being pivotally coupled to said at least two leg members of said top support plate.

2. The vehicle lifting device operable to utilize compressed air for operation thereof as recited in claim 1, wherein said at least two mounting arm have a notch formed therein distal to said center portion of said base plate member, said notch configured to have said lower end of said lower portion of said at least two articulating arm members operably disposed therein.

3. The vehicle lifting device operable to utilize compressed air for operation thereof as recited in claim 2, wherein said upper end of said lower portion of said at least two articulating arm members have an arcuate shaped portion, wherein said arcuate shaped portion is contiguously formed with an upper surface of said lower portion of said at least two articulating arm members.

4. The vehicle lifting device operable to utilize compressed air for operation thereof as recited in claim 3, wherein said arcuate shaped portion terminates into an extension segment, said extension segment being coplanar with a lower surface of said lower portion of said at least two articulating arm members.

5. The vehicle lifting device operable to utilize compressed air for operation thereof as recited in claim 4, wherein said extension segment engages said lower end of said upper portion of said at least two articulating arm members when the vehicle lifting device is fully extended upward.

6. The vehicle lifting device operable to utilize compressed air for operation thereof as recited in claim 5, and further including an extension member, said extension member being releasably secured to said top support plate being superposed thereto, said extension member extending substantially across said top support plate.

7. The vehicle lifting device operable to utilize compressed air for operation thereof as recited in claim 6, wherein said extension member includes a base member, said base member having block members secured to an upper surface thereof.

8. The vehicle lifting device operable to utilize compressed air for operation thereof as recited in claim 7, wherein said extension member includes a pair of mounting posts, said mounting posts being movably secured into a bottom surface of said base member, said mounting post having a lower portion, wherein said lower portion being configured to be journaled into holes formed in said top support plate.

9. The vehicle lifting device operable to utilize compressed air for operation thereof as recited in claim 8, wherein said lower end of said upper portion of said at least two articulating arm members is surroundably mounted to the upper end of said lower portion of said at least two articulating arm members having opposing leg members that are adjacent opposing sides of the upper end of said lower portion of said at least two articulating arm members.

10. The vehicle lifting device operable to utilize compressed air for operation thereof as recited in claim 9, wherein said at least two leg members of said top support plate include a notch, said notch of said at least two leg members of said top support plate configured to have operably inserted thereinto said upper end of said upper portion of said at least two articulating arm members.

11. The vehicle lifting device operable to utilize compressed air for operation thereof as recited in claim 10, wherein said at least two mounting arm members have 180 degrees of separation therebetween.

12. The vehicle lifting device operable to utilize compressed air for operation thereof as recited in claim 11, wherein said pair of mounting posts are rotationally movable in order to provide variable adjustment of a height of the extension member.
